(19) United States
(12) Patent Application Publication
(10) Pub. No.: US 2025/0271592 A1
(43) Pub. Date: Aug. 28, 2025

(54) OBSERVATION DEVICE AND METHOD

(71) Applicant: Nippon Telegraph and Telephone Corporation, Tokyo (JP)

(72) Inventors: Go Itami, Musashino-shi, Tokyo (JP); Tsuneko Kura, Musashino-shi, Tokyo (JP); Hiroshi MATSUBARA, Musashino-shi, Tokyo (JP); Masaki HISADA, Musashino-shi, Tokyo (JP)

(21) Appl. No.: 18/850,621

(22) PCT Filed: Apr. 19, 2022
(86) PCT No.: PCT/JP2022/018149

§ 371 Date: Sep. 25, 2024

(51) Int. Cl. G01W 1/08

(52) U.S. Cl. CPC G01W 1/08

(57) ABSTRACT

An observation apparatus 1 includes a floating structure 10 floating on a water surface 100, a balloon 20 filled with a gas lighter than air and floating in the air, a hollow wire rod 30 connecting the floating structure 10 and the balloon 20, and a sensor 40 installed in the balloon 20 or the wire rod 30, and replenishes the balloon 20 with the gas through the hollow portion 31 of the wire rod 30.

### TECHNICAL FIELD

The present invention relates to an observation apparatus and an observation method.

### BACKGROUND ART

A current key technology in global environment monitoring is satellite remote sensing. Satellite remote sensing employs a sensing method using a microwave band synthetic aperture radar or a sensing method using visible light and infrared rays. In those methods, it is possible to find a spatial distribution and temporal transition of a ground surface, a deforestation damage situation, ozone holes, clouds, aerosols, and harmful gases (NO₂, SO₂, or the like) by observing a change in scattering and reflection spectra of radio waves or light incident on the earth. This information can be used for weather prediction, environmental protection, disaster prevention, and the like. However, the above method is a combination of image processing of a captured image, other preliminary information, and a statistical method, and there are many methods that are merely estimation that is not based on actual data. In addition, due to the nature of the measurement method, sensing resolution in a vertical direction is not sufficient, and there is room for significant improvement in reliability and sensing resolution of the data.

On the other hand, as environmental monitoring on the ground, observation based on periodic actual data such as air pollution, human flow measurement, CO₂ concentration, temperature, and humidity is also performed. Although data reliability can be secured by using actual data with which observation conditions can be understood in detail, there is a problem that the number of measurement points and measurement range are limited. Similarly, environmental monitoring activities in the ocean are also implemented. For example, environmental monitoring in the ocean includes fixed point observation using a ship or a buoy, observation in a wide range using a sea current, measurement of a temperature in the sea in a deep portion by changing the density of the buoy, and the like (see Non Patent Literature 1).

By combining satellite data with ground and marine data, it can be expected to secure spatial and temporal coverage and high reliability of data. That is, by linking an autonomous sensor network that is constructed based on the concept of the Internet of Things (IoT) and can be placed anywhere on the earth with a satellite remote sensing technology, sensing can be further advanced as a monitoring technology of the entire earth. For example, various pieces of information from various IoT sensors are collectively transmitted to a satellite, and an enormous amount of information is collectively transmitted to a ground station together with information on the satellite sensing conditions, so that it is possible to create 3D mapping information with high data reliability in which specific sensor information obtained by combining satellite data with terrestrial and marine data is reflected.

### CITATION LIST

### Non Patent Literature

Non Patent Literature 1: “Weather buoy”, [online], [retrieved on Mar. 17, 2022], the Internet <URL: https://en.wikipedia.org/wiki/Weather_buoy>

### SUMMARY OF INVENTION

### Technical Problem

From the viewpoint of expansion of direct actual measurement data without using a satellite, it is important to establish a measurement method in an atmospheric vertical direction, which is an unsatisfactory area for satellite remote sensing. Long time fixed point observation on the ocean is often performed using a buoy. However, a conventional buoy observes a point where a sensor is installed, and cannot perform observation in the atmospheric vertical direction with high spatial resolution.

The present invention has been made in view of the above, and an object thereof is to continuously acquire weather information in an atmospheric vertical direction for a long time.

### Solution to Problem

An observation apparatus according to an aspect of the present invention includes: a floating structure floating on a water surface; a floating body that is filled with a gas lighter than air and floats in the air; a hollow wire rod connecting the floating structure and the floating body; and a sensor installed on the floating body or the wire rod, in which the gas is replenished to the floating body through a hollow portion of the wire rod.

### Advantageous Effects of Invention

According to the present invention, weather information in the atmospheric vertical direction can be continuously acquired for a long time.

### BRIEF DESCRIPTION OF DRAWINGS

FIG. 1 is a diagram illustrating an example of a configuration of an observation apparatus according to a first example.

FIG. 2 is a top view illustrating an example of a floating structure.

FIG. 3 is a diagram illustrating an example of a configuration of an observation apparatus according to a second example.

FIG. 4 is a diagram illustrating an example of a configuration of an observation apparatus according to a third example.

FIG. 5 is a diagram illustrating an example of a configuration of a mobile sensor.

### DESCRIPTION OF EMBODIMENTS

Hereinafter, an embodiment of the present invention will be described using the drawings.

### Example 1

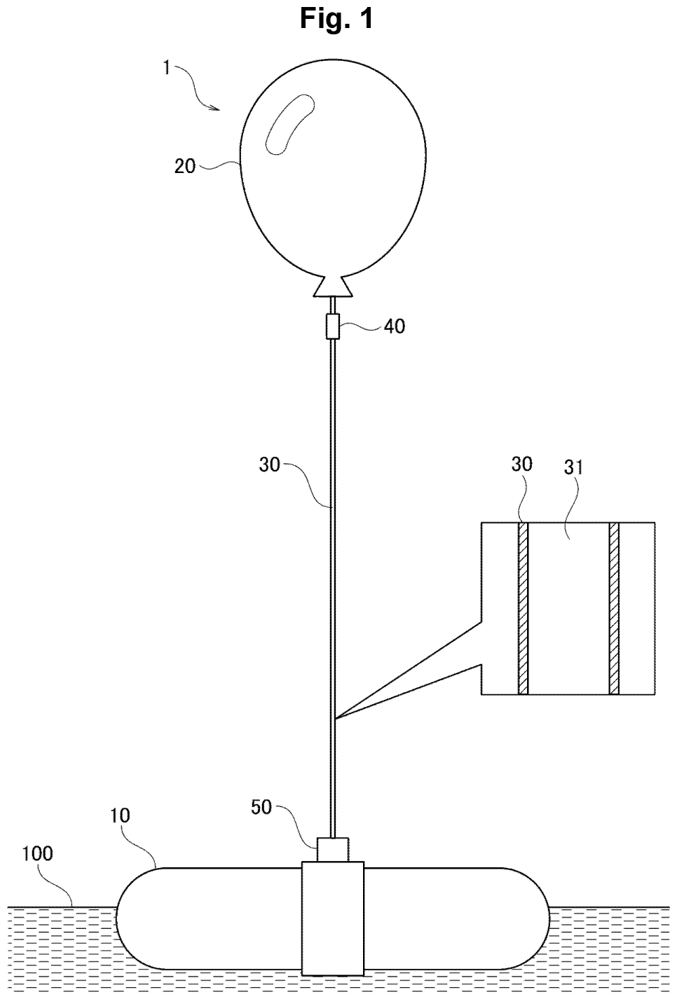

An example of a configuration of an observation apparatus 1 according to a first example will be described with reference to FIG. 1. The observation apparatus 1 illustrated in FIG. 1 includes a floating structure 10, a balloon 20, a wire rod 30, a sensor 40, and a regulating valve 50.

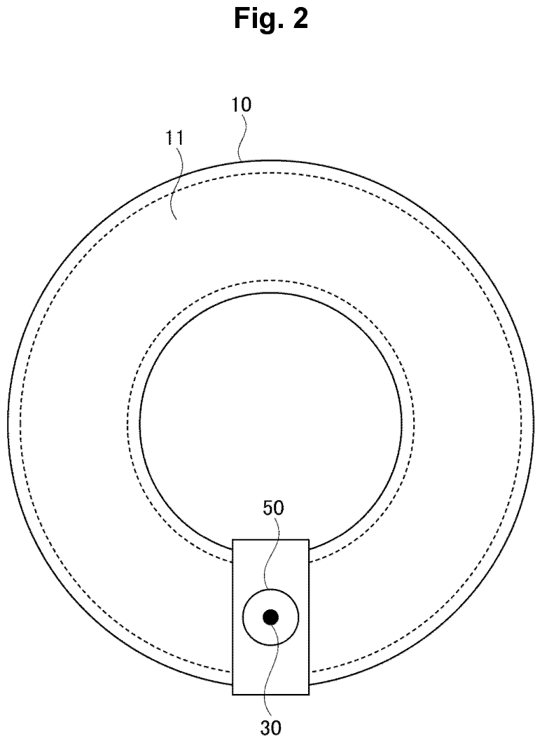

The floating structure 10 is a structure floating on a water surface 100 such as a sea or a lake. The floating structure 10 may float on the water surface 100 or may be powered and movable. For example, a marine observation facility such as a buoy or a ship can be used as the floating structure 10. In the present embodiment, as illustrated in FIG. 2, the floating structure 10 has a donut shape. Note that the shape of the floating structure 10 is not limited to a donut shape. The floating structure 10 is used as a cylinder container, and a gas for replenishing the balloon 20 is stored in a donut-shaped interior 11. A cylinder container storing gas may be provided inside the floating structure 10 or may be mounted outside the floating structure 10.

The balloon 20 is a floating body that is filled with a gas lighter than air (for example, hydrogen or helium) and floats in the air.

The wire rod 30 is a hollow linear material that connects the floating structure 10 and the balloon 20. One end of the wire rod 30 is connected to a mouth of the balloon 20, and the other end is connected to the interior 11 of the floating structure 10 or the cylinder container, so that the balloon 20 is replenished with gas through a hollow portion 31 of the wire rod 30.

The sensor 40 is installed on the balloon 20 or the wire rod 30, and acquires weather information in the atmospheric vertical direction. For example, the sensor 40 measures temperature, humidity, wind speed, intensity of ultraviolet rays, concentration of carbon dioxide, or the like. The sensor 40 may transmit measurement data in a wireless manner or may store the measurement data in a memory included in the sensor 40. The floating structure 10 may include storage devices to receive and store the measurement data transmitted by sensors 40. The measurement data transmitted by the sensor 40 may be received by a ship at a position away from the observation apparatus 1 or a base station on land, or may be received by an unmanned airplane flying near the observation apparatus 1 or a satellite.

The regulating valve 50 is attached to the wire rod 30 to adjust a replenishment amount of the gas replenished from the cylinder to the balloon 20. By constantly measuring the air pressure in the balloon 20 and controlling the gas replenishment amount by the regulating valve 50, the balloon 20 always contains the minimum necessary gas. As a result, the balloon 20 can be prevented from being unnecessarily inflated too much, and an outflow of the gas can be minimized. Based on a size of the balloon 20 or a height of the balloon 20, the replenishment amount necessary for maintaining a buoyancy of the balloon 20 constant may be estimated.

Next, an example of an observation method using the observation apparatus 1 will be described.

First, an observer floats the floating structure 10 on the sea at the observation point. When the floating structure 10 is powered, the floating structure 10 may move to the observation point.

After the floating structure 10 is floated at the observation point, the balloon 20 is filled with gas via the wire rod 30.

The balloon 20 filled with the gas rises, and the sensor 40 is disposed at a desired height.

The sensor 40 starts measuring and transmits or accumulates measurement data.

When the air pressure in the balloon 20 falls below a predetermined value, the regulating valve 50 is controlled so that the gas is replenished from the floating structure 10 into the balloon 20 through the hollow portion of the wire rod 30. As a result, lowering of the altitude of the balloon 20 can be suppressed and the sensor 40 can be maintained at a desired height.

### Example 2

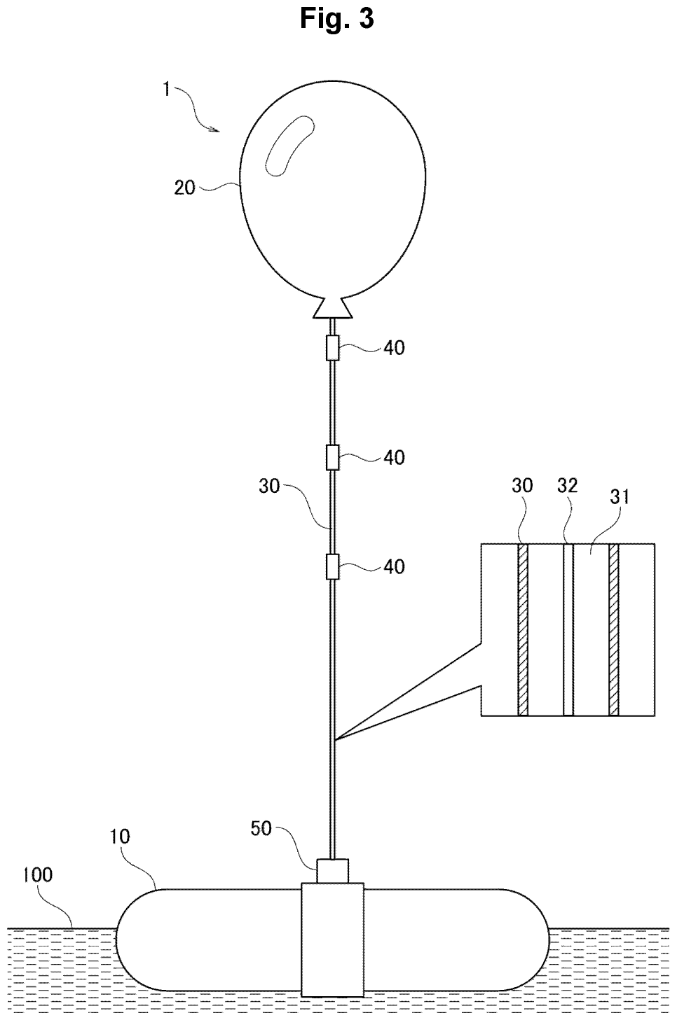

An example of a configuration of the observation apparatus 1 according to the second example will be described with reference to FIG. 3. The observation apparatus 1 illustrated in FIG. 3 includes a floating structure 10, a balloon 20, a wire rod 30, a plurality of sensors 40, and a regulating valve 50. The observation apparatus 1 according to the second example is different from the observation apparatus 1 according to the first example in that a plurality of sensors 40 are provided.

Depending on a type of information acquired by the sensor 40, a lightweight sensor 40 can be used. If the lightweight sensor 40 is used, an influence on the buoyancy of the balloon 20 can be suppressed even if the number of sensors 40 is increased. By installing the plurality of sensors 40, it is possible to perform observation in the atmospheric vertical direction with high spatial resolution. In the plurality of sensors 40, the same type of sensors 40 may be disposed apart from each other, or different types of sensors 40 may be disposed.

In the example of FIG. 3, the sensors 40 are connected to each other through a communication line 32 in the hollow portion of the wire rod 30. As a result, the plurality of sensors 40 can be measured in synchronization. Furthermore, the floating structure 10 may include an information processing device, the communication line 32 may be connected to the information processing device, and the information processing device may collect measurement data from the sensor 40.

By providing the plurality of sensors 40, it is possible to improve measurement accuracy by comparing measurement values between the sensors 40 with each other in time series and leveling errors. For example, the accuracy of the measured value can be improved by estimating a distribution in which a variation is formed from the comparison between the similar conditions, and applying statistical processing to raw data at the time of observation by utilizing the average, the variance, and the like as prior information.

Note that the configuration is not limited to the configuration in which the sensors 40 are connected by the communication line 32, and wireless communication may be used.

### Example 3

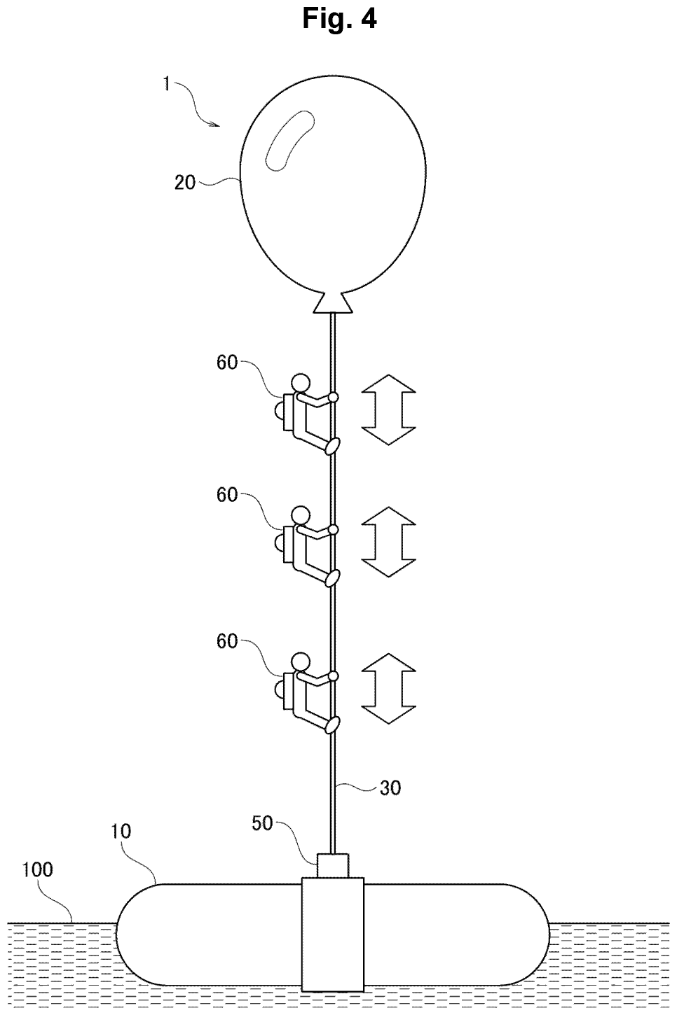

An example of a configuration of the observation apparatus 1 according to the third example will be described with reference to FIG. 4. The observation apparatus 1 illustrated in FIG. 4 includes a floating structure 10, a balloon 20, a wire rod 30, a mobile sensor 60, and a regulating valve 50. The observation apparatus 1 according to the third example is different from the observation apparatuses 1 according to the first and second example in that a mobile sensor 60 is provided.

The mobile sensor 60 is a sensor having a structure that moves along the wire rod 30. By moving the mobile sensor 60, measurement data having a spatial resolution equal to or greater than the number of sensors can be collected. In addition, when observation environment deteriorates or an amount of remaining energy is small, the mobile sensor 60 moves to the floating structure 10 and evacuates, so that a sustainability of measurement can be improved. For example, the mobile sensor 60 predicts rainfall from a combination of temperature and humidity measured by itself, and evacuates to the floating structure 10 when it is likely to rain. Floating structure 10 is provided with a place where mobile sensor 60 can be evacuated.

The observation apparatus 1 of FIG. 4 includes a plurality of mobile sensors 60. Each of the mobile sensors 60 may move position independently. The mobile sensor 60 may move according to a positional relationship with another mobile sensor 60. The mobile sensors 60 may move synchronously with one another. Note that only one mobile sensor 60 may be provided.

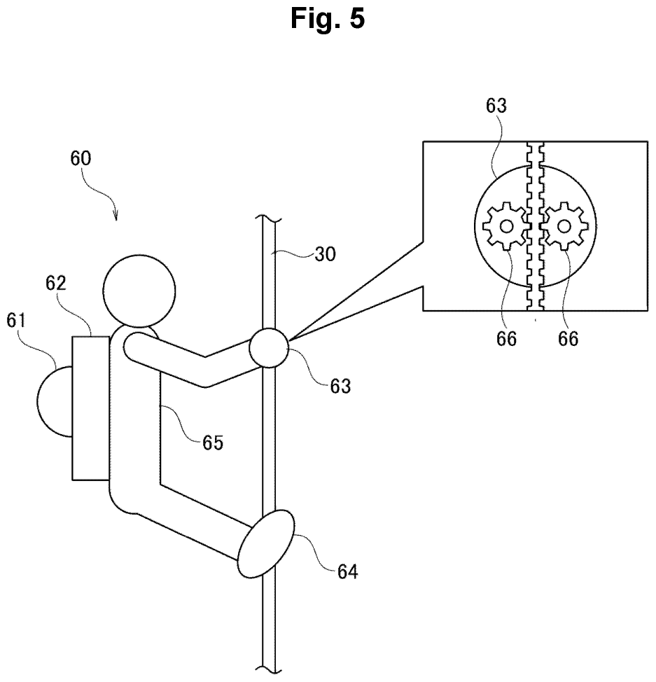

Next, an example of a configuration of the mobile sensor 60 will be described with reference to FIG. 5. A mobile sensor 60 illustrated in FIG. 5 is a sensor of a humanoid robot, and includes a sensor 61, a solar cell 62, a hand 63, a foot 64, and a control unit 65.

Similarly to the sensors of in the first and second example, the sensor 61 measures the environment in the atmospheric vertical direction and transmits measurement data.

The solar cell 62 provides energy for moving the mobile sensor 60.

The hand 63 and the foot 64 have a function of gripping the wire rod 30 and moving up and down along the wire rod 30. For example, the hand 63 and the foot 64 are configured to be openable and closable, and one set of gears 66 is provided inside the openable and closable portion. The hand 63 and the foot 64 are closed, the wire rod 30 is sandwiched between the gears 66, and the gear 66 is rotated to move the mobile sensor 60 up and down.

When each of the hand 63 and the foot 64 is opened, the mobile sensor 60 can be detached from the wire rod 30. The mobile sensor 60 may stand on the floating structure 10 in a state of being detached from the wire rod 30 and walk on two legs. On the sea, since the floating structure 10 swings and a scaffold is unstable, an electromagnet may be attached to the back of the foot 64 to be attracted to the floating structure 10. For example, when the mobile sensor 60 walks, the electromagnets of the left and right feet 64 are alternately operated to advance while one of the feet 64 is attracted to the floating structure 10.

The control unit 65 utilizes remaining energy amount data and sensor acquired data to control the action of the mobile sensor 60 according to the mobile sensor 60 itself and the surrounding situation.

In the third example, a humanoid robot is used as the mobile sensor 60, but the present invention is not limited thereto. It is sufficient that the mobile sensor 60 is mounted with the sensor 61 and can move up and down on the wire rod 30.

As described above, the observation apparatus 1 of the present embodiment includes the floating structure 10 floating on the water surface 100, the balloon 20 filled with a gas lighter than air and floating in the air, the hollow wire rod 30 connecting the floating structure 10 and the balloon 20, and the sensor 40 installed in the balloon 20 or the wire rod 30, and replenishes the balloon 20 with the gas through the hollow portion 31 of the wire rod 30. As a result, the atmospheric vertical distribution of the weather information in the ocean can be continuously acquired for a long time. Note that there is sufficient room for future consideration of buoys used for conventional observation on the ocean, such as the buoy must be manually installed and replaced, the number of measurement points is limited for the same reason, recovery of broken buoys is difficult, and there is a limit of a measurement period due to battery life (Non Patent Literature 1). By using the observation apparatus 1 of the present embodiment, it is possible to realize a long time and continuous measurement, and if the floating structure 10 has power, it is possible to more easily install, replace, and collect the observation apparatus 1.

Since the observation apparatus 1 includes the plurality of sensors 40 or the mobile sensor 60, it is possible to perform observation in the atmospheric vertical direction with high spatial resolution. In addition, the accuracy of the measurement value can be improved by measuring the plurality of sensors 40 in synchronization and correcting the measurement data by statistically processing the measurement data of the plurality of sensors 40.

By autonomously moving the mobile sensor 60 according to the mobile sensor 60 itself or the surrounding situation, the failure frequency and the maintenance frequency can be greatly reduced.

### REFERENCE SIGNS LIST

1 Observation apparatus
10 Floating structure
11 Interior
20 Balloon
30 Wire rod
31 Hollow portion
32 Communication line
40 Sensor
50 Regulating valve
60 Mobile sensor
61 Sensor
62 Solar cell
63 Hand
64 Foot
65 Control unit
66 Gear
100 Water surface

1. An observation apparatus, comprising:
a floating structure floating on a water surface;
a floating body that is filled with a gas lighter than air and floats in the air;
a hollow wire rod connecting the floating structure and the floating body; and
a sensor installed on the floating body or the wire rod,
wherein the gas is replenished to the floating body through a hollow portion of the wire rod.

2. The observation apparatus according to claim 1, further comprising
a regulating valve that adjusts an amount of the gas replenished to the floating body.

3. The observation apparatus according to claim 1, further comprising
a plurality of sensors,
wherein measurement data of the plurality of sensors is statistically processed to correct the measurement data.

4. The observation apparatus according to claim 1, wherein
the sensor is movable along the wire rod.

5. An observation method comprising:
connecting a floating body to a floating structure floating on a water surface with a wire rod to float the floating body in the air;
measuring with a sensor installed on the floating body or the wire rod; and
replenishing the floating body with a gas through a hollow portion of the wire rod.

6. The observation method according to claim 5, further comprising
adjusting an amount of the gas replenished to the floating body according to a state of the floating body.

7. The observation method according to claim 5, wherein
the sensor moves along the wire rod.
